(19) United States
(12) Patent Application Publication
(10) Pub. No.: US 2017/0347693 A1
(43) Pub. Date: Dec. 7, 2017

(54) Method for producing a codfish fritter mix

(71) Applicant: Elizabeth Colon, Ponce, PR (US)

(72) Inventor: Elizabeth Colon, Ponce, PR (US)

(21) Appl. No.: 15/614,368

(22) Filed: Jun. 5, 2017

Related U.S. Application Data
(60) Provisional application No. 62/345,059, filed on Jun. 3, 2016.

(51) Int. Cl. A23L 17/00

(52) U.S. Cl. CPC A23L 17/75; A23V 2002/00

(57) ABSTRACT

The present invention includes a process for making a liquid codfish fritter mix easy to use and ready for cooking without the need of adding other ingredients.

### CROSS-REFERENCE TO RELATED APPLICATION

N/A

### STATEMENT REGARDING FEDERALLY SPONSORED RESEARCH AND DEVELOPMENT

N/A

### BACKGROUND OF THE INVENTION

### Field of the Invention

The present invention relates to a codfish fritter mix, more particularly to a method for producing a durable ready-to-use codfish fritter mix.

### Discussion of the Background

The codfish fritter is a dish mostly consume in the Caribbean islands. The codfish fritters also called “bacalaitos” are crisp on the outside and most of the time chewy in the inside. Currently several markets sell powder codfish fritter mix that is not ready to use. The powder need to be mix with water and several ingredients in order to complete or provide the required mix to made the codfish fritter. Therefore there is a need for providing a codfish fritter mix ready-to-use in order to simplify the time in the kitchen.

In light of the above shortcoming a product and method for a coldfish fritter is provided in order to simplify the amount of work in the kitchen.

### SUMMARY OF THE INVENTION

The primary objective of this invention is to present a product and method for providing an easy to make and ready-to-use gourmet codfish fritter mix.

It is an object of the present invention to provide a tasty codfish fritter mix that preserves it quality for a long period of time.

It is an object of the present invention to provide a tasty codfish fritter mix wherein the expiration date is more than 6 moths.

Another object of the present invention to provide a liquid codfish fritter mix ready to be used without struggling with the process of mixing ingredients.

To enable a better understanding of the objective and features of the present invention, a brief description of the drawing below will be followed with a detailed description of invention.

### BRIEF DESCRIPTION OF THE DRAWINGS

FIG. 1 is a flowchart of the first preferred embodiment of the present invention.

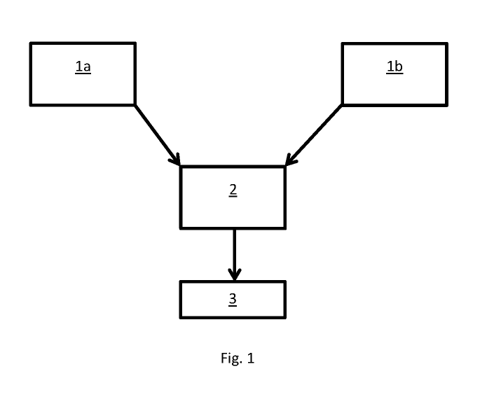

### DETAILED DESCRIPTION OF THE INVENTION

In accordance with the principles of the present invention the product and process simplifies the process and product provided by powder mixtures. Further, the present disclosure provides a gourmet product. The ingredient combination and procedure provides exquisite taste that differs from those available in the market. In addition the process and combination of ingredients assists with the expiration time of the mixture by increasing the lifespan of the mixture for a longer period of time when it is compared to the mix powder.

Product:

| Amount | | Ingredient |
|---|---|---|
| 1 | lb | Boneless salted cod fillet, |
| 4 | lbs | Wheat Flour |
| 7.5 | cup | Flavored codfish water |
| 6.5 | cup | Distilled water |
| 1/2 | tbsp | Yeast |
| 16 | oz | Flavor mix |
| Flavor mix (amount) | | Ingredients |
| 2.5 | tbsp | Achiote |
| 1/4 | tsp | Cumin Powder |
| 1/4 | tsp | Oregano Powder |
| 1/2 | tbsp | Extra Virgin Olive Oil |
| 1/8 | cup | Fresh Cilantro |
| 1/2 | tbsp | Minced garlic |
| 1/2 | tbsp | Recao or Fresh Coriander |
| 1/3 | cup | Yellow Onion |
| 1/4 | cup | Green Peppers |
| 1/3 | cup | Red Pepper |
| 1/2 | tbsp | Sweet Peppers |

Process:

Prepare Flavor mix 1a
Dispose all Flavor mix ingredients into a food processor.
Mix flavor mix ingredients

Prepare the cod fillet 1b
In a cooking pot pour the cod fillet and 10 cups of water until its boiling, when it's start boiling remove it from the heat.
Take out 8 cups of the water from the pot.
Boil it again, when it start boiling remove the pot from the heat.
Leave it until it's cool down (from the 8 cups of water we are only using 7.5 cups)
Once it's cool down, take out 7.5 cups of water (flavored codfish water) and pour in a approximately in a 3 gallon container.

Prepare the liquid codfish fritter mix 2
On the 3 gallon container pour the 6.5 cups of distilled water,
Add the 4 pounds of wheat flour to the container
Add yeast
Mix the waters with the wheat flour and the yeast, until the yeast it's fully dissolve
Shred the codfish, then mix it with all the ingredients including the one's that you put on the food processor.
Let it sit for 1 hour

Freeze the liquid codfish fritter mix 3
Put the liquid codfish fritter mix in freezer at a temperature below 0 degrees Celsius.

After congelation the codfish fritter mix product is ready for distribution. The lifespan of the product is approximately 1 year while it is keep in a freezer. In order to use the product just take the container with the mixture, let it sit until it's defrosted, and it's ready for frying in hot oil.

In summary of the previous sections, the invention presents advantages not available at the moment with existing current market. While the invention has been described as having a preferred product and process, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patentable distinguish any amended claims from any applied prior art.

What is claimed is:

1. A method for preparing a ready-to-use gourmet codfish fritter mix that preserves its quality and taste for a long period of time, the method comprising steps of:
a. preparing a flavor mix;
b. preparing a boneless salted cod fillet;
c. preparing a liquid ready-to-use gourmet codfish fritter mix; and
d. freezing the liquid ready-to-use gourmet codfish fritter mix.

2. The method in claim 1, wherein the flavor mix comprises a 2.5 tbsp. of Achiote, a ¼ tsp of Cumin Powder, a ¼ tbsp. of Oregano Powder, a ½ tbsp. of extra Virgin Olive Oil, a ⅛ cup of Fresh Cilantro, a 1/2 tbsp. of Minced garlic, a 1/2 tbsp. of recao, a 1/3 cup of Yellow Onion, a 1/4 cup of Green Peppers, a 1/3 cup of Red Pepper and a 1/2 tbsp. of Sweet Peppers.

3. The method in claim 2, wherein preparing a flavor mix comprises pouring said flavor mix into a food processor, wherein said food processor diced and mix the flavor mix.

4. The method in claim 1 wherein in preparing a boneless salted cod fillet comprise the steps of:
a. pouring 10 cups of water and a 16 oz. boneless salted cod fillet into a cooking pot until boiling;
b. removing the cooking pot from the heat once it starts boiling;
c. taking out 8 cups of water from the cooking pot and collecting the water in a separate container and leave it to cool down;
d. adding 8 cups of water to the cooking pot with the 16 oz. boneless salted cod fillet and put the cooking pot in the heat to boil again;
e. removing the cooking pot from the heat when it starts boiling again.
f. taking 7.5 cups of water from the separate container and pouring them into a 3-gallon container once it cools down; and
g. Leaving the 16 oz. boneless salted cod fillet to cool down.

5. The method in claim 1 wherein preparing the liquid ready-to-use gourmet codfish fritter mix comprises the steps of:
a. pouring 6.5 cups of distilled water into the 3-gallon container;
b. adding 4 pounds of wheat flour to the 3-gallon container;
c. adding ½ tbsp. of yeast to the 3-gallon container;
d. mixing the ingredients in the 3-gallon container until the yeast is fully dissolved;
e. shredding the 16 oz. boneless salted codfish fillet;
f. mixing the shredded 16 oz. boneless salted codfish fillet with the food mass resulting of step 4(b) and the food mass resulted from claim 2;
g. Letting the liquid ready-to-use gourmet codfish fritter mix sit for approximately 1 hour before freezing.

6. The method in claim 1 wherein freezing the liquid ready-to-use gourmet codfish fritter mix comprises the steps of (d) freezing the liquid ready-to-use gourmet codfish fritter mix at a temperature of below 0 Celsius degrees.

7. A codfish fritter mix, which comprises:
(a) a combination of a boneless salted cod fillet, flour, flavored codfish water, water, yeast and;
(b) a flavor mix, wherein said flavor mix includes achiote, cumin, oregano, olive oil, cilantro garlic, coriander, onion, green pepper, red pepper and sweet pepper.
